(19) United States
(12) Patent Application Publication
(10) Pub. No.: US 2026/0161557 A1
(43) Pub. Date: Jun. 11, 2026

(54) METHOD FOR RECOVERING MAPPING TABLE, MEMORY CONTROLLER AND STORAGE DEVICE

(71) Applicant: Samsung Electronics Co., Ltd., Suwon-si (KR)

(72) Inventors: Chan Ha KIM, Suwon-si (KR); Ji Yeun KANG, Suwon-si (KR); Young Jo PARK, Suwon-si (KR); Jong Hwa KIM, Suwon-si (KR); Se Hwan LEE, Suwon-si (KR)

(21) Appl. No.: 19/310,165

(22) Filed: Aug. 26, 2025

(30) Foreign Application Priority Data
Dec. 11, 2024 (KR) 10-2024-0183878

(51) Int. Cl. G06F 12/06

(52) U.S. Cl. CPC G06F 12/06; G06F 2212/72

(57) ABSTRACT

A method for recovering mapping table includes detecting a first region in which an error has occurred in a mapping table stored in a first memory, estimating a second physical page number (PPN) corresponding to a second logical page number (LPN) of the first region based on a first PPN corresponding to a first LPN of a second region in which an error has not occurred, reading metadata recorded in memory cells corresponding to a physical address of the estimated second PPN from a nonvolatile memory device, and determining whether a third LPN included in the metadata is matched with the second LPN.

### CROSS-REFERENCE TO RELATED APPLICATION(S)

This application claims priority under 35 U.S.C. § 119 to Korean Patent Application No. 10-2024-0183878 filed on Dec. 11, 2024 in the Korean Intellectual Property Office, the disclosure of which in its entirety is herein incorporated by reference.

### BACKGROUND

### 1. Technical Field

The present disclosure relates to a method for recovering a mapping table, a memory controller and a storage device.

### 2. Description of the Related Art

Memory devices are classified into volatile memory devices and nonvolatile memory devices. The volatile memory devices include a dynamic random access memory (DRAM) and a static random access memory (SRAM). The nonvolatile memory devices include a flash memory, an electrically erasable programmable read-only memory (EEPROM), and a resistive memory.

The flash memory of the nonvolatile memory devices includes a plurality of blocks, each of the plurality of blocks includes a plurality of pages, and each of the plurality of pages includes a plurality of memory cells.

The flash memory performs read and write operations of data in units of pages and performs an erase operation in units of memory blocks. In order to solve problems that may occur due to such physical characteristics of the flash memory, the flash memory uses a flash translation layer (FTL). The flash translation layer serves to translate a logical address defined by a host into a physical address used in the flash memory. The flash translation layer performs an address translation operation based on a mapping table. In this case, mapping information recorded in the mapping table may be damaged for various reasons. Therefore, it is desired that the mapping table is easily recovered when the mapping table is damaged.

### SUMMARY

An object of the present disclosure is to provide a method for recovering a damaged mapping table.

Another object of the present disclosure is to provide a memory controller for recovering a damaged mapping table.

Other object of the present disclosure is to provide a storage device to which a storage controller for recovering a damaged mapping table is applied.

According to some embodiment of present disclosure, a method for recovering mapping table includes detecting a first region in which an error has occurred in a mapping table stored in a first memory, estimating a second physical page number (PPN) corresponding to a second logical page number (LPN) of the first region based on a first PPN corresponding to a first LPN of a second region in which an error has not occurred, reading metadata recorded in memory cells corresponding to a physical address of the estimated second PPN from a nonvolatile memory device, and determining whether a third LPN included in the metadata is matched with the second LPN.

According to some embodiments of present disclosure, a memory controller includes a processing circuit configured to control an operation of a nonvolatile memory device, and a first memory configured to store a mapping table including mapping between a logical page number (LPN) and a physical page number (PPN) used in the nonvolatile memory device. The processing circuit includes an error detection unit configured to detect a first region in which an error has occurred in the mapping table, a PPN estimation unit configured to estimate a second PPN corresponding to a second LPN of the first region based on a first PPN corresponding to a first LPN of the second region in which an error has not occurred in the mapping table, and an LPN checking unit configured to read metadata recorded in memory cells corresponding to a physical address of the estimated second PPN from the nonvolatile memory device and determine whether a third LPN included in the metadata is matched with the second LPN.

According to some embodiments of present disclosure, a storage device includes a nonvolatile memory device configured to store data, and a storage controller configured to control an operation of the nonvolatile memory device, detect a first region in which an error has occurred in a mapping table, estimate a second PPN corresponding to a second LPN of the first region based on a first PPN corresponding to a first LPN of a second region in which an error has not occurred in the mapping table, read metadata recorded in memory cells corresponding to a physical address of the estimated second PPN from the nonvolatile memory device, and determine whether a third LPN included in the metadata is matched with the second LPN.

The objects of the present disclosure are not limited to those mentioned above and additional objects of the present disclosure, which are not mentioned herein, will be clearly understood by those skilled in the art from the following description of the present disclosure.

Details of the other embodiments are included in the detailed description and drawings.

### BRIEF DESCRIPTION OF THE DRAWINGS

FIG. 1 is a block diagram illustrating a storage system according to example embodiments.

FIG. 2 is a block diagram illustrating a nonvolatile memory device according to example embodiments.

FIGS. 3 and 4 are views illustrating a memory cell array according to example embodiments.

FIGS. 5 and 6 are views illustrating a mapping table according to example embodiments.

FIG. 7 is a view illustrating valid bitmap information.

FIG. 8 is a block diagram illustrating a processing circuit according to example embodiments.

FIG. 9 is a flow chart illustrating a method for recovering a mapping table according to example embodiments.

FIG. 10 is a block diagram illustrating a processing circuit according to example embodiments.

FIG. 11 is a flow chart illustrating a method for recovering a mapping table according to example embodiments.

FIG. 12 is a block diagram illustrating a storage device according to example embodiments.

### DETAILED DESCRIPTION OF THE DISCLOSURE

Hereinafter, the embodiments according to the technical spirits of the present disclosure will be described with reference to the accompanying drawings.

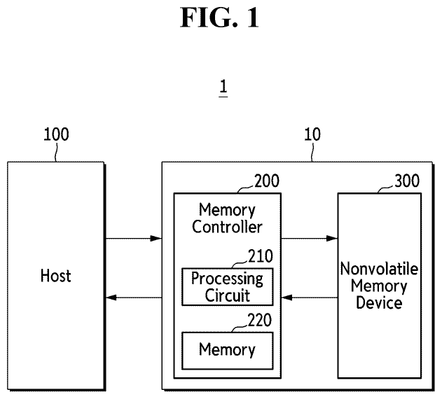

FIG. 1 is a block diagram illustrating a storage system according to example embodiments.

Referring to FIG. 1, a storage system 1 may include a host 100 and a storage device 10. The storage device 10 may include a memory controller 200 and a nonvolatile memory device 300, but the embodiments are not limited thereto. The host 100, the memory controller 200 and the nonvolatile memory device 300 may be integrated in one apparatus.

The host 100 may make a read or write request to the memory controller 200 by using an application or a system. The memory controller 200 may control an operation (for example, a read or write operation) of the nonvolatile memory device 300 in response to the request from the host 100.

A unit of the read and write operations may be different from a unit of an erase operation in the nonvolatile memory device 300. For example, the nonvolatile memory device 300 may perform the erase operation in units of memory blocks, and may perform the read and write operations in units of pages. Also, the nonvolatile memory device 300 may not support overwrite unlike the other semiconductor memory devices. Therefore, the nonvolatile memory device 300 may be required to perform the erase operation before the write operation.

The nonvolatile memory device 300 may include a plurality of memory cells having a string cell structure. A set of such memory cells may be referred to as a memory cell array. The memory cell array of the nonvolatile memory device 300 may include a plurality of memory blocks. Each memory block may include a plurality of pages. Each page may include a plurality of memory cells sharing one word line. In this case, an address in which data of the nonvolatile memory device 300 is recorded may be divided by a physical page number (PPN). On the other hand, the host 100 uses a logical address and may request the logical address to read or write data. The logical address may be divided by a logical page number (LPN). Since the logical address used by the host 100 is different from the physical address used by the nonvolatile memory device 300, mapping between the logical address and the physical address may be required.

The memory controller 200 may include a processing circuit 210 and a memory 220. The memory controller 200 may control the operation of the nonvolatile memory device 300. For example, the processing circuit 210 of the memory controller 200 may execute firmware when power is applied to the storage device 10. The firmware may include a host interface layer (HIL) that receives a request from the host 100 or outputs a response according to the request to the host 100, a flash translation layer (FTL) that processes the request received from the host 100, and a flash interface layer (FIL) that provides a command to the nonvolatile memory device 300 or receives a response from the nonvolatile memory device 300. For example, the processing circuit 210 may include a host core, a flash core, and the like. The host core may execute the host interface layer (HIL) to receive a request from the host 100 or output a response according to the request to the host 100. The flash core may execute the flash translation layer (FTL) to process the request received from the host 100.

According to some embodiments, the processing circuit 210 may manage mapping between the logical page number (LPN) and the physical page number (PPN) by executing the flash translation layer (FTL). The processing circuit 210 may execute the flash translation layer (FTL) to record a mapping relation between the LPN and the PPN in a mapping table.

The memory 220 may store the mapping table in which the mapping relation between the LPN and the PPN is recorded. The memory 220 may be used as at least one of an operation memory of the processing circuit 210, a cache memory between the nonvolatile memory device 300 and the host 100, or a buffer memory. The memory 220 may be located in the memory controller 200, but may be located in the storage device 10 by being separated from the memory controller 200, or may be implemented as a portion of the nonvolatile memory device 300. The memory 220 may be implemented as a volatile memory (e.g., a static random access memory (SRAM), a dynamic RAM (DRAM), a synchronous RAM (SDRAM), etc.) or a nonvolatile memory (a flash memory, a phase-change RAM (PRAM), a magneto-resistive RAM (MRAM), a resistive RAM (ReRAM), a ferro-electric RAM (FRAM), etc.).

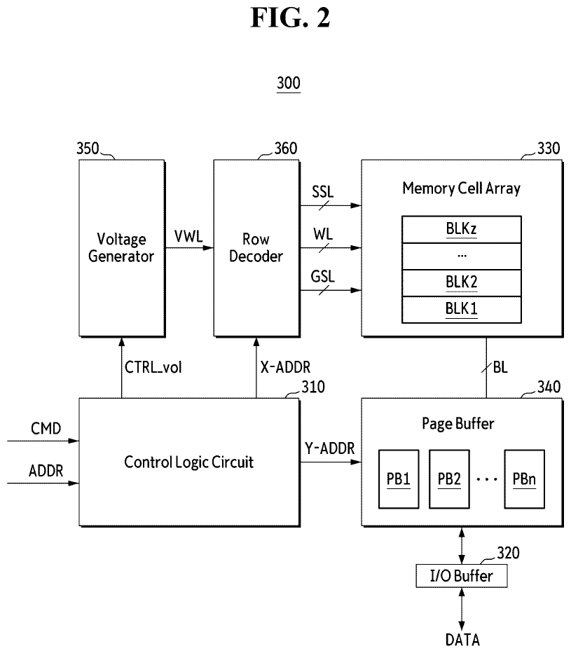

FIG. 2 is a block diagram illustrating a nonvolatile memory device according to example embodiments.

Referring to FIG. 2, the nonvolatile memory device 300 may include a memory cell array 330, a voltage generator 350, a row decoder 360, a page buffer 340, an input/output circuit (or input/output buffer) 320, and a control logic circuit 310. The memory cell array 330 may include a plurality of memory blocks BLK1 to BLKz, z may be a natural number greater than or equal to 2. Each of the plurality of memory blocks BLK1 to BLKz may be connected to the row decoder 360 through a plurality of word lines WL, a plurality of string selection lines SSL, and a plurality of ground selection lines GSL, and may be connected to the page buffer 340 through a plurality bit lines BL.

The memory cell array 330 may include a plurality of memory cells arranged in regions where the plurality of word lines WL cross the plurality of bit lines BL. Each of the memory cells may be formed in various cell types including a single level cell (SLC), a multi level cell (MLC), a triple level cell (TLC), a quad level cell (QLC), etc.

The control logic circuit 310 may generate a control signal CTRL_vol for controlling the voltage generator 350 and a control signal (not shown) for controlling the page buffer 340 by receiving a command CMD, an address ADDR, and a control signal CTRL (not shown), and may generate a row address X_ADDR and a column address Y_ADDR based on the address ADDR. The control logic circuit 310 may output the row address X_ADDR to the row decoder 360, and may output the column address Y_ADDR to the page buffer 340.

The voltage generator 350 may regulate a word line basic voltage VWL for a memory operation in accordance with the control signal CTRL_vol from the control logic circuit 310, and may provide the word line basic voltage VWL to the memory cell array 330 through the row decoder 360.

The row decoder 360 may be connected to the memory cell array 330 through the word lines WL, the string selection lines SSL and the ground selection lines GSL. The row decoder 360 may decode the row address X_ADDR input from the control logic circuit 310 to select at least one of the plurality of memory blocks BLK1 to BLKz. For example, the row decoder 360 may select a word line WL, a string selection line SSL and a ground selection line GSL by using the row address X_ADDR. The row decoder 360 may provide the word line basic voltage VWL supplied from the voltage generator 350 to the word lines WL.

The page buffer 340 may be connected to the memory cell array 330 through the bit lines BL, and may be connected to the input/output circuit 320 through the bit lines BL. During a program operation, the input/output circuit 320 may receive program data DATA provided from the memory controller 200, and may provide the program data DATA to the page buffer 340 based on the column address Y_ADDR provided from the control logic circuit 310. During a read operation, the input/output circuit 320 may provide read data DATA stored in the page buffer 340 to an external device (e.g., the memory controller 200) based on the column address Y_ADDR provided from the control logic circuit 310.

The control logic circuit 310 may control the overall operation of the nonvolatile memory device 300 and output each control signal related to the memory operation. For example, the control logic circuit 310 may control the nonvolatile memory device 300 by using an internal control signal based on at least one of the address ADDR, the command CMD or the control signal CTRL, which is received from the memory controller 200.

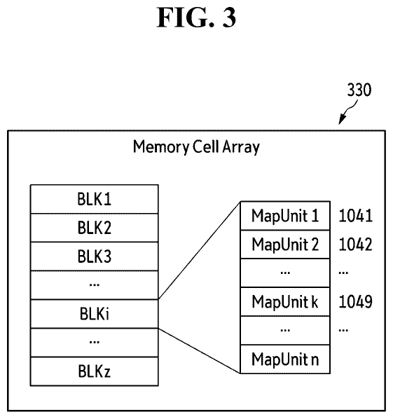

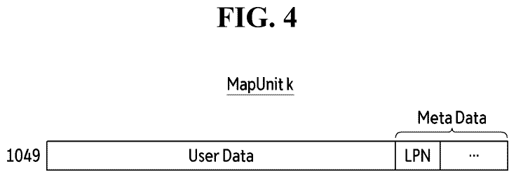

FIGS. 3 and 4 are views illustrating a memory cell array according to example embodiments.

Referring to FIGS. 3 and 4, the memory cell array 330 may include a plurality of memory blocks BLK1 to BLKz, and each of the plurality of memory blocks BLK1 to BLKz may include a plurality of map units MapUnit 1 to MapUnit n (‘n’ is a natural number). One map unit may be a data storage space allocated to one PPN. For example, a PPN corresponding to data stored in the map unit MapUnit 1 may be, for example, 1041. Also, the PPN corresponding to data stored in the map unit MapUnit k may be, for example, 1049. User data and metadata may be stored in one map unit. For example, each map unit may include a plurality of memory cells. The user data may be data that the host desires to store in memory cells of the nonvolatile memory device. The metadata may be data used for the operation of the nonvolatile memory device except the user data. The metadata stored in one map unit (e.g., corresponding memory cells) may include an LPN corresponding to the PPN of the corresponding map unit. For example, when the metadata for any map unit is read, the LPN corresponding to the map unit may be identified.

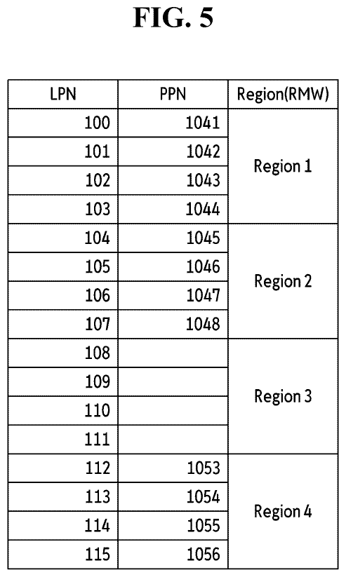

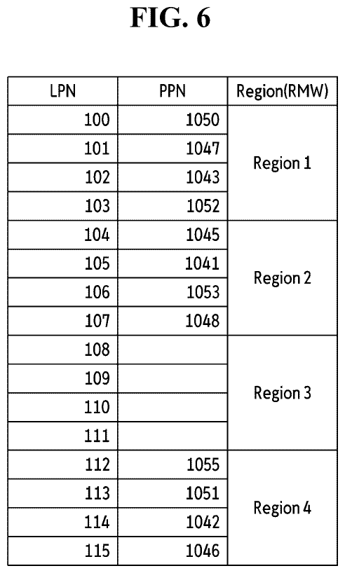

FIGS. 5 and 6 are views illustrating a mapping table according to example embodiments.

Referring to FIGS. 5 and 6, mapping between an LPN used by a host (100 of FIG. 1) and a PPN used by a nonvolatile memory device (300 of FIG. 1) may be recorded in the mapping table. The mapping table may be recorded by a memory controller (200 of FIG. 1) and stored in a memory (220 of FIG. 1). When the memory uses the same address system as that of the host, the LPN may not be required to be separately recorded, and an address number of the memory may be an LPN, but the embodiments are not limited thereto. The LPN may be separately recorded in the memory. A plurality of LPNs may respectively have a plurality of PPNs corresponding thereto. The plurality of PPNs may be written in the mapping table at a time in accordance with a read-modify-write (RMW) command.

When the mapping table is written in the memory, two patterns may be present in the mapping table. The mapping table in which the PPNs are sequentially recorded as shown in FIG. 5 may be a sequential pattern. Assuming the mapping table shown in FIG. 5, a PPN of a physical address corresponding to a logical address of which LPN is 106 in a second region in which an error has not occurred is 1047, and a PPN of a physical address corresponding to a logical address of which LPN is 107, which is the next logical address of which LPN is 106, is 1048. In this way, when two PPNs corresponding to two continuous LPNs are also continuous, the mapping table may be determined as the mapping table of the sequential pattern in which the PPNs are sequentially recorded.

The mapping table in which the PPNs are randomly recorded as shown in FIG. 6 may be a random pattern. Assuming the mapping table shown in FIG. 6, a PPN of a physical address corresponding to a logical address of which LPN is 106 in a second region in which an error has not occurred is 1053, and a PPN of a physical address corresponding to a logical address of which LPN is 107, which is the next logical address of which LPN is 106, is 1048. In this way, when two PPNs corresponding to two continuous LPNs are not continuous, the mapping table may be determined as the mapping table of the random pattern in which the PPNs are randomly recorded. However, a method of determining whether the PPNs are randomly recorded (whether or not a random pattern) or sequentially recorded (whether or not a sequential pattern) is not limited to the above method.

In this case, an error may occur in some of the data recorded in the mapping table due to various causes. For example, some of the PPNs recorded in the mapping table may be in an Uncorrectable Error Correction Code (UECC) state. When any one of a plurality of PPNs written in accordance with the RMW command is in the UECC state due to an error in data of any one of the plurality of PPNs, a corresponding region may be in the UECC state. For example, when any one of a plurality of PPNs written in a third region is in the UECC state due to an error in data of any one of the plurality of PPNs, all of the PPNs written in the third region may be in the UECC state. When some of the data in the mapping table is lost, the storage device may operate in error.

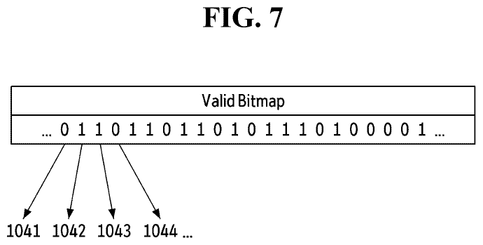

FIG. 7 is a view illustrating valid bitmap information.

Referring to FIG. 7, the memory controller may record and store valid bitmap information indicating whether data recorded in memory cells of the nonvolatile memory device corresponding to physical addresses of a plurality of PPNs are valid, in a volatile memory (e.g., the memory 220 of FIG. 1). The valid bitmap information may be data of m bits (where ‘m’ is a natural number), and one bit of the m bits may indicate information corresponding to each of the plurality of PPNs. For example, one bit may indicate whether data recorded in the memory cells corresponding to a physical address of a corresponding PPN is valid. For example, the one bit may indicate “1” when the data corresponding to the physical address of the corresponding PPN is valid. The one bit of “1” may mean that the data recorded in the memory cells corresponding to the physical address of the corresponding PPN is the latest data and is valid data. The one bit of “0” may mean that the data recorded in the memory cells corresponding to the physical address of the corresponding PPN is not the latest data and is invalid data. Assume that the valid bitmap information shown in FIG. 7 is stored in the volatile memory. Data recorded in memory cells corresponding to the physical address of the PPN having address numbers 1041 and 1044 may be invalid data. Data recorded in memory cells corresponding to the physical address of the PPN having address numbers 1042 and 1043 may be valid data.

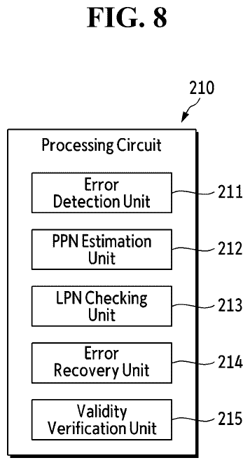

FIG. 8 is a block diagram illustrating a processing circuit according to example embodiments.

Referring to FIG. 8, the processing circuit 210 may include an error detection unit 211, a PPN estimation unit 212, an LPN checking unit 213, and an error recovery unit 214. The error detection unit 211, the PPN estimation unit 212, the LPN checking unit 213 and the error recovery unit 214 may be implemented as dedicated hardware or dedicated circuit in the processing circuit 210, for example. The processing circuit 210 may implement, for example, the error detection unit 211, the PPN estimation unit 212, the LPN checking unit 213 and the error recovery unit 214 by executing firmware, and may be implemented as dedicated hardware or combination of dedicated circuit and firmware.

The error detection unit 211 may detect, for example, a first region in which an error has occurred in the mapping table. As a detailed example, the error detection unit 211 may detect the first region in which UECC has occurred in the mapping table. Assuming the mapping table shown in FIG. 5, the error detection unit 211 may detect the third region in which an error has occurred in the mapping table.

The PPN estimation unit 212 may estimate a second PPN corresponding to a second LPN of the first region based on the first LPN and the first PPN of the second region in which an error has not occurred. In order to describe the operation of the PPN estimation unit 212, the mapping table shown in FIG. 5 is assumed. The PPN estimation unit 212 may estimate a second PPN corresponding to a second LPN of a third region based on the first LPN of the second region in which an error has not occurred and the first PPN corresponding to the first LPN. In this case, the first LPN and the second LPN may be continuous. For example, the address number of the first LPN may be 107, and the address number of the second LPN may be 108. In case of the mapping table in which the PPNs are sequentially recorded, since the first PPN and the second PPN may be continuous when the first LPN and the second LPN are continuous, the second PPN may be estimated. For example, since the address number of the first PPN corresponding to the first LPN is 1048, the PPN estimation unit 212 may estimate that the address number of the second PPN is 1049.

The LPN checking unit 213 may read metadata from memory cells of the nonvolatile memory device corresponding to the physical address of the estimated second PPN, and may determine whether a third LPN included in the metadata is matched with the second LPN. In order to describe the operation of the LPN checking unit 213, the mapping table shown in FIG. 5 is assumed. The LPN checking unit 213 may read metadata from memory cells of the nonvolatile memory device corresponding to the physical address of the estimated second PPN (e.g., the PPN having an address number of 1049). For example, when the address number of the third LPN included in the metadata is 108, since the address number of the third LPN is matched with the address number of the second LPN, the LPN checking unit 213 may determine that the third LPN included in the metadata is matched with the second LPN. On the other hand, when the address number of the third LPN included in the metadata is not 108, since the address number of the third LPN is not matched with the address number of the second LPN, the LPN checking unit 213 may determine that the third LPN included in the metadata is not matched with the second LPN.

In response to determining that the third LPN included in the metadata is matched with the second LPN, the error recovery unit 214 may update the PPN corresponding to the second LPN to the estimated second PPN. In order to describe the operation of the error recovery unit 214, the mapping table shown in FIG. 5 is assumed. When the estimated address number of the second PPN is 1049, the error recovery unit 214 may update the address number of the PPN corresponding to the second LPN (e.g., the LPN having an address number of 108) to 1049 in the mapping table.

According to some embodiments, the processing circuit 210 may further include a validity verification unit 215. The validity verification unit 215 may be implemented as dedicated hardware or dedicated circuit in the processing circuit 210, for example. The processing circuit 210 may implement the validity verification unit 215 by executing, for example, firmware, or may be implemented as dedicated hardware or combination of the dedicated circuit and firmware.

The validity verification unit 215 may determine, for example, the validity of the estimated PPN. When determining the validity of the estimated PPN, the validity verification unit 215 may determine the validity based on the valid bitmap information stored in the volatile memory. In order to describe the operation of the validity verification unit 215, the mapping table of FIG. 5 and the valid bitmap information of FIG. 7 are assumed. For example, when the PPN estimation unit 212 estimates that the address number of the second PPN is 1049, the validity verification unit 215 may determine the validity of the estimated second PPN by reading a bit corresponding to the estimated second PPN. Since the address number of the second PPN is 1049, the corresponding bit indicates “1”, whereby the validity verification unit 215 may determine that the estimated second PPN is valid. When the corresponding bit indicates “0”, the validity verification unit 215 may determine that the estimated second PPN is not valid.

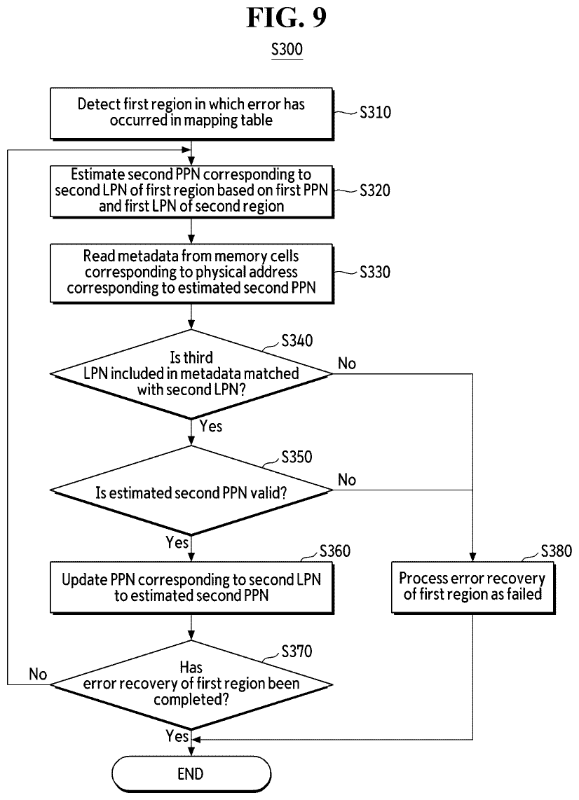

FIG. 9 is a flow chart illustrating a method for recovering a mapping table according to example embodiments.

Referring to FIG. 9, a method S300 for recovering a mapping table includes detecting a first region in which an error (e.g., UECC) has occurred in the mapping table (S310). For example, the processing circuit may detect the first region in which an error has occurred in the mapping table. As a detailed example, the processing circuit may detect the first region in which UECC has occurred in the mapping table. Assuming the mapping table shown in FIG. 5, the processing circuit may detect the third region in which an error has occurred in the mapping table.

According to some embodiments, the method S300 for recovering a mapping table includes estimating a second PPN corresponding to the second LPN of the first region based on the first PPN and the first LPN of the second region in which an error has not occurred in the mapping table (S320). For example, the processing circuit may estimate the second PPN corresponding to the second LPN of the first region based on the first LPN and the first PPN of the second region in which an error has not occurred. In order to describe the operation S320, the mapping table shown in FIG. 5 is assumed. The processing circuit may estimate the second PPN corresponding to the second LPN of the third region based on the first LPN of the second region in which an error has not occurred and the first PPN corresponding to the first LPN. In this case, the first LPN and the second LPN may be continuous. For example, the address number of the first LPN may be 107, and the address number of the second LPN may be 108. In case of the mapping table in which the PPNs are sequentially recorded, since the first PPN and the second PPN may be continuous when the first LPN and the second LPN are continuous, the processing circuit may estimate the second PPN. For example, since the address number of the first PPN corresponding to the first LPN is 1048, the processing circuit may estimate that the address number of the second PPN is 1049. The embodiment of the present disclosure is not limited to estimating PPNs one by one, and the processing circuit may estimate a plurality of PPNs at once, unlike the above case.

According to some embodiments, the method S300 for recovering a mapping table includes reading metadata from the memory cells of the nonvolatile memory device corresponding to the physical address of the estimated second PPN (S330). For example, the processing circuit may read metadata from the memory cells of the nonvolatile memory device corresponding to the physical address of the estimated second PPN. In order to describe the operation S330, the mapping table shown in FIG. 5 is assumed. The processing circuit may read metadata from the memory cells of the nonvolatile memory device corresponding to the physical address of the estimated second PPN (e.g., PPN having an address number of 1049). The metadata may include information on the LPN corresponding to the corresponding PPN.

According to some embodiments, the method S300 for recovering a mapping table includes determining whether the third LPN included in the metadata is matched with the second LPN (S340). The processing circuit may determine whether the third LPN included in the metadata corresponding to the physical address of the estimated second PPN is matched with the second LPN. In order to describe the operation S340, the mapping table shown in FIG. 5 is assumed. For example, when the address number of the third LPN included in the metadata is 108, the address number of the third LPN is matched with the address number of the second LPN, and thus the processing circuit may determine that the third LPN included in the metadata is matched with the second LPN. On the other hand, when the address number of the third LPN included in the metadata is not 108, the address number of the third LPN is not matched with the address number of the second LPN, and thus the processing circuit may determine that the third LPN included in the metadata is not matched with the second LPN.

According to some embodiments, the method S300 for recovering a mapping table includes determining whether the estimated second PPN is valid (S350) in response to determining that the third LPN included in the metadata is matched with the second LPN (S340-Y). For example, when determining the validity of the estimated PPN, the processing circuit may determine the validity based on the valid bitmap information stored in the volatile memory. In order to describe the operation S350, the mapping table of FIG. 5 and the valid bitmap information of FIG. 7 are assumed. For example, the processing circuit may estimate that the address number of the second PPN is 1049 and determine validity of the estimated second PPN by reading a bit corresponding to the estimated second PPN. Since the address number of the second PPN is 1049, the corresponding bit indicates “1”, whereby the processing circuit may determine that the estimated second PPN is valid. When the corresponding bit indicates “0”, the processing circuit may determine that the estimated second PPN is not valid.

According to some embodiments, the method S300 for recovering a mapping table includes updating a PPN corresponding to the second LPN to the estimated second PPN (S360) in response to determining that the estimated second PPN is valid (S350-Y). In order to describe the operation S360, the mapping table shown in FIG. 5 is assumed. When the estimated address number of the second PPN is 1049, the processing circuit may update the address number of the PPN corresponding to the second LPN (e.g., LPN having an address number of 108) to 1049 in the mapping table.

According to some embodiments, the method S300 for recovering a mapping table includes determining whether errors of all PPNs in the first region have been recovered (S370). In order to describe the operation S370, the mapping table shown in FIG. 5 is assumed. There may be one or more PPNs to be recovered in the first region. In case of FIG. 5, four PPNs need to be recovered. When the processing circuit determines that errors of all PPNs in the first region have been recovered (S370-Y), the error recovery of the mapping table is terminated. When the processing circuit determines that errors of all PPNs in the first region have not been recovered (S370-N), the method may be repeated in order to recover the next PPN of the recovered PPN (e.g., for the next PPN of the recovered PPN, the operations S320 to S370 may be repeated).

According to some embodiments, the method S300 for recovering a mapping table includes processing the error recovery in the first region as failed by the processing circuit (S380) in response to determining that the third LPN included in the metadata is not matched with the second LPN (S340-Y). For example, the processing circuit may display an error uncorrectable PPN in the first region of the mapping table. Afterwards, the error recovery of the mapping table is terminated.

When the bit corresponding to the estimated PPN indicates “0”, since data recorded in memory cells corresponding to a physical address of the corresponding PPN should be erased, it may not be necessary to recover the PPN. Therefore, according to some embodiments, the method S300 for recovering a mapping table includes processing the error recovery in the first region as failed by the processing circuit (S380) in response to determining that the estimated second PPN is not valid (S350-N). For example, the processing circuit may display an error uncorrectable PPN in the first region of the mapping table. Afterwards, the error recovery of the mapping table is terminated.

According to some embodiments, even though an error occurs in a portion of the mapping table, a PPN of a region in which an error has occurred may be recovered by detecting the region in which an error has occurred in the mapping table, estimating the PPN corresponding to the LPN of the corresponding region, reading the estimated PPN and determining whether the LPN of the read PPN is matched with the LPN of the corresponding region in accordance with the above method. According to the above method, since it is not necessary to read all the metadata stored in the nonvolatile memory to recover the region in which an error has occurred in the mapping table, the error that has occurred in the mapping table may be quickly recovered.

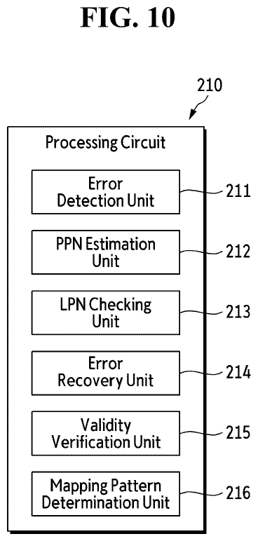

FIG. 10 is a block diagram illustrating a processing circuit according to example embodiments.

Descriptions of redundant portions of those described in FIG. 8 will be omitted in FIG. 10. Referring to FIG. 10, the processing circuit 210 may further include a mapping pattern determination unit 216. The mapping pattern determination unit 216 may be implemented as dedicated hardware or dedicated circuit in the processing circuit 210, for example. The processing circuit 210 may implement the mapping pattern determination unit 216 by executing firmware, for example, or may be implemented as dedicated hardware or combination of dedicated circuit and firmware.

For example, the mapping pattern determination unit 216 may determine whether the mapping pattern of the mapping table is a sequential pattern, based on a plurality of LPNs of the second region in which an error has not occurred and a plurality of PPNs respectively corresponding to the plurality of LPNs. In order to describe the mapping pattern determination unit 216, the mapping table shown in FIG. 5 is assumed. The PPN of the physical address corresponding to the logical address of which LPN is 106 in the second region in which an error has not occurred is 1047, and the PPN of the physical address corresponding to the logical address of which LPN is 107, which is the next logical address of the logical address of which LPN is 106, is 1048. In this way, when two PPNs corresponding to two continuous LPNs are also continuous, the mapping pattern determination unit 216 may determine that the mapping table is a sequential pattern.

In order to describe the mapping pattern determination unit 216, the mapping table shown in FIG. 6 is assumed. The PPN of the physical address corresponding to the logical address of which LPN is 106 in the second region in which an error has not occurred is 1053, and the PPN of the physical address corresponding to the logical address of which LPN is 107, which is the next logical address of the logical address of which LPN is 106, is 1048. In this way, when two PPNs corresponding to two continuous LPNs are not continuous, the mapping pattern determination unit 216 may determine that the mapping table is not a sequential pattern but is a random pattern.

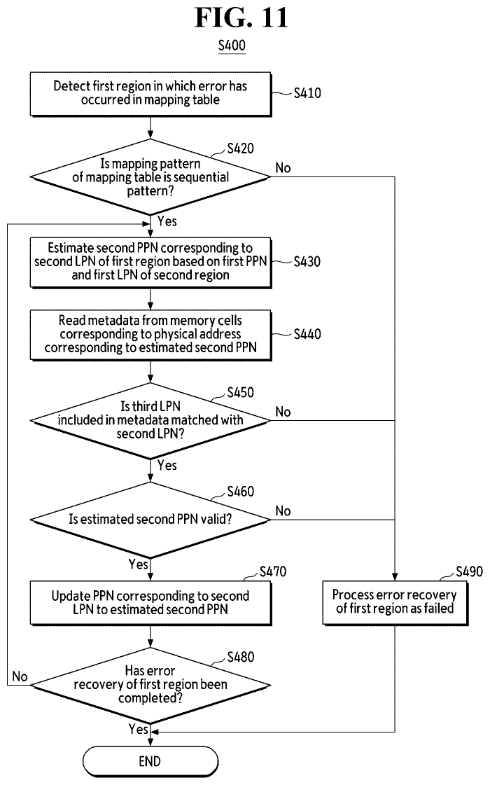

FIG. 11 is a flow chart illustrating a method for recovering a mapping table according to example embodiments.

Descriptions of redundant portions of those described in FIG. 9 will be omitted in FIG. 11. Referring to FIG. 11, a method S400 for recovering a mapping table includes detecting a first region in which an error (e.g., UECC) has occurred in the mapping table (S410), and determining whether the mapping pattern of the mapping table is a sequential pattern (S420). For example, the processing circuit may determine whether the mapping pattern of the mapping table is a sequential pattern, based on a plurality of LPNs of the second region in which an error has not occurred and a plurality of PPNs respectively corresponding to the plurality of LPNs. In order to describe the operation S420, the mapping table shown in FIG. 5 is assumed. The PPN of the physical address corresponding to the logical address of which LPN is 106 in the second region in which an error has not occurred is 1047, and the PPN of the physical address corresponding to the logical address of which LPN is 107, which is the next logical address of the logical address of which LPN is 106, is 1048. In this way, when two PPNs corresponding to two continuous LPNs are also continuous, the processing circuit may determine that the mapping table is a sequential pattern.

In order to describe the operation S420, the mapping table shown in FIG. 6 is assumed. The PPN of the physical address corresponding to the logical address of which LPN is 106 in the second region in which an error has not occurred is 1053, and the PPN of the physical address corresponding to the logical address of which LPN is 107, which is the next logical address of the logical address of which LPN is 106, is 1048. In this way, when two PPNs corresponding to two continuous LPNs are not continuous, the processing circuit may determine that the mapping table is not a sequential pattern but is a random pattern.

According to some embodiments, the method S400 for recovering a mapping table includes estimating a second PPN corresponding to the second LPN of the first region based on the first PPN and the first PPN of the second region in which an error has not occurred in the mapping table (S430) in response to determining that the mapping pattern of the mapping table is a sequential pattern (S420-Y), reads metadata from memory cells of the nonvolatile memory device corresponding to a physical address of the estimated second PPN (S440), determines whether the third LPN included in the metadata is matched with the second LPN (S450), determines whether the estimated second PPN is valid (S460) in response to determining that the third LPN included in the metadata is matched with the second LPN (450-Y), updates the PPN corresponding to the second LPN to the estimated second PPN (S470) in response to determining that the estimated second PPN is valid (S460-Y), determines whether errors of all PPNs in the first region have been recovered (S480), and terminates error recovery in the mapping table in response to determining that errors in all PPNs in the first region have been recovered (S480-Y). In response to determining that all PPN errors in the first region have not been recovered (S480-N), the above method may be repeated to recover the next PPN of the recovered PPN (for example, for the next PPN of the recovered PPN, the operations S430 to S480 may be repeated).

When the mapping pattern of the mapping table is not a sequential pattern (is a random pattern), since two PPNs corresponding to two continuous LPNs may not be continuous, the PPN may not be estimated. Therefore, the method S400 for recovering a mapping table includes processing the error recovery in the first region as failed (S490) in response to determining that the mapping pattern of the mapping table is not a sequential pattern (S420-N). For example, the processing circuit may display an error uncorrectable PPN in the first region of the mapping table. Afterwards, the error recovery of the mapping table is terminated.

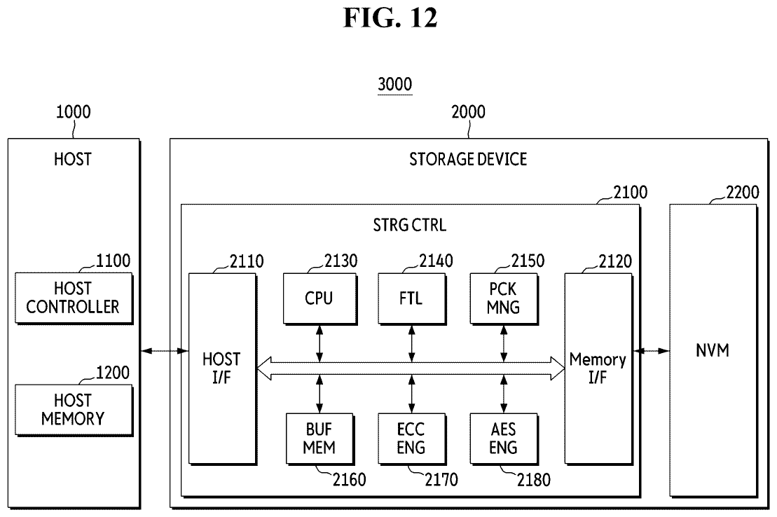

FIG. 12 is a block diagram illustrating a storage device according to example embodiments.

Referring to FIG. 12, a host-storage system 3000 may include a host 1000 and a storage device 2000. The storage device 2000 may include a storage controller 2100 and a nonvolatile memory (NVM) 2200. The host 1000 may include a host controller 1100 and a host memory 1200. The host memory 1200 may serve as a buffer memory for temporarily storing data to be transmitted to the storage device 2000 or data transmitted from the storage device 2000.

The storage device 2000 may include storage media for storing data in accordance with a request from the host 1000. As an example, the storage device 2000 may include at least one of a solid state drive (SSD), an embedded memory, or a detachable external memory. When the storage device 2000 is the SSD, the storage device 2000 may be a device that complies with the standard of a nonvolatile memory express (NVMe). When the storage device 2000 is the embedded memory or the external memory, the storage device 2000 may be a device that complies with the standard of a universal flash storage (UFS) or an embedded multi-media card (eMMC). Each of the host 1000 and the storage device 2000 may generate and transmit packets according to a standard protocol that is employed.

When the NVM 2200 of the storage device 2000 includes a flash memory, the flash memory may include a 2D NAND memory array or a 3D (or vertical) NAND (VNAND) memory array. As another example, the storage device 2000 may include other various types of nonvolatile memories. For example, a magnetic random access memory (MRAM), a spin-transfer torque MRAM, a Conductive Bridging RAM (CBRAM), a Ferroelectric RAM (FeRAM), a Phase RAM (PRAM), a Resistive RAM and other various types of memories may be applied to the storage device 2000.

Each of the host controller 1100 and the host memory 1200 may be implemented as a separate semiconductor chip. Alternatively, the host controller 1100 and the host memory 1200 may be integrated into the same semiconductor chip. As an example, the host controller 1100 may be any of a plurality of modules provided in an application processor, and the application processor may be implemented as a system on chip (SoC). In addition, the host memory 1200 may be an embedded memory provided in the application processor, or may be a nonvolatile memory or memory module arranged outside the application processor.

The host controller 1100 may store data (e.g., write data) of a buffer region in the NVM 2200, or may manage an operation of storing data (e.g., read data) of the NVM 2200 in the buffer region.

The storage controller 2100 may include a host interface 2110, a storage-memory interface 2120 and a central processing unit (CPU) 2130. The storage controller 2100 may further include a flash translation layer (FTL) 2140, a packet manger 2150, a buffer memory 2160, an error correction code (ECC) engine 2170 and an advanced encryption standard (AES) engine 2180. The storage controller 2100 may further include a working memory in which the flash translation layer 2140 is loaded, and the CPU 2130 may control data write and read operations for the NVM 2200 by executing the flash translation layer 2140.

In detail, the storage device 2000 may receive a storage device driving signal from the host 1000 through the host interface 2110. The CPU 2130 may transmit an initialization command in response to the storage device driving signal. The initialization command may be transmitted to the NVM 2200 through the storage-memory interface 2120.

The host interface 2110 may transmit and receive packets to and from the host 1000. The packets transmitted from the host 1000 to the host interface 2110 may include a command or data to be written in the NVM 2200, and the packets transmitted from the host interface 2110 to the host 1000 may include a response to the command or data read from the NVM 2200. The storage-memory interface 2120 may transmit the data to be written in the NVM 2200 to the NVM 2200 or may receive the data read from the NVM 2200. Such a storage-memory interface 2120 may be implemented to comply with standard protocols such as Toggle or Open NAND Flash Interface (ONFI).

The flash translation layer 2140 may perform various functions such as address mapping, wear-leveling and garbage collection. The address mapping operation is an operation of changing a logical address received from the host 1000 to a physical address used to actually store data in the NVM 2200. The wear-leveling is a technique for preventing excessive degradation of a specific block by allowing blocks in the NVM 2200 to be used uniformly, and may exemplarily be implemented through firmware technology for balancing erase counts of physical blocks. The garbage collection is a technique for making sure of the available capacity in the NVM 2200 by copying valid data of a block to a new block and then erasing the existing block.

The packet manger 2150 may generate packets according to a protocol of an interface negotiated with the host 1000 or parse various kinds of information from the packets received from the host 1000. Also, the buffer memory 2160 may temporarily store data to be written in the NVM 2200 or data to be read from the NVM 2200.

The buffer memory 2160 may be provided in the storage controller 2100, but may be arranged outside the storage controller 2100.

The ECC engine 2170 may perform error detection and correction functions for the read data read from the NVM 2200. In more detail, the ECC engine 2170 may generate parity bits for write data to be written in the NVM 2200, and the generated parity bits may be stored in the NVM 2200 together with the write data. When reading the data from the NVM 2200, the ECC engine 2170 may correct an error of the read data by using the parity bits read from the NVM 2200 together with the read data, and then may output the error-corrected read data.

The AES engine 218 may perform at least one of an encryption operation or a decryption operation for the data input to the storage controller 2100 by using a symmetric-key algorithm.

According to some embodiments, a portion of the NVM 2200 may be implemented as the above-described nonvolatile memory device (300 of FIG. 1). For example, the NVM 2200 may include one or more nonvolatile memory devices (300 of FIG. 1). The storage controller 2100 may correspond to the memory controller (200 of FIG. 1) described above. The storage controller 2100 may further include a processing circuit for controlling the storage controller 2100. The processing circuit may include dedicated hardware or a dedicated circuit for performing the following operations, and may implement units for performing the following operations by executing firmware. The storage controller 2100 may be configured to detect a first region in which an error has occurred in a mapping table stored in a working memory in which a flash translation layer is executed, to estimate a second PPN corresponding to a second LPN of a first region based on a first PPN corresponding to a first LPN of a second region in which an error has not occurred in the mapping table, to read metadata recorded in memory cells corresponding to a physical address of the second PPN estimated by the NVM 2200, and to determine whether a third LPN included in the metadata is matched with the second LPN.

The storage controller 2100 may be configured to further determine whether a mapping pattern of the mapping table is a sequential pattern, based on a plurality of LPNs of the second region and a plurality of PPNs corresponding to the plurality of LPNs.

The storage controller 2100 may be configured to further determine validity of the second PPN, and the storage controller 2100 may be configured to further determine the validity of the second PPN based on valid bitmap information.

When the second LPN is an LPN continuous from the first LPN, the storage controller 2100 may be configured to estimate that a PPN continuous from the first PPN is a second PPN.

The storage controller 2100 may be configured to update the estimated second PPN to a PPN corresponding to the second LPN in response to determining that the third LPN is matched with the second LPN.

While the inventive concept has been particularly shown and described with reference to embodiments thereof, it will be understood that various changes in form and details may be made therein without departing from the spirit and scope of the present invention as set forth in the following claims.

What is claimed is:

1. A method for recovering a mapping table, the method comprising:
detecting a first region in which an error has occurred in a mapping table stored in a first memory;
estimating a second physical page number (PPN) corresponding to a second logical page number (LPN) of the first region based on a first PPN corresponding to a first LPN of a second region in which an error has not occurred;
reading metadata recorded in memory cells corresponding to a physical address of the estimated second PPN from a nonvolatile memory device; and
determining whether a third LPN included in the metadata is matched with the second LPN.

2. The method of claim 1, further comprising:
determining whether a mapping of the mapping table is a sequential pattern, based on a plurality of LPNs of the second region and a plurality of PPNs corresponding to the plurality of LPNs.

3. The method of claim 1, further comprising:
determining whether the second PPN is valid.

4. The method of claim 3, wherein the determining whether the second PPN is valid is performed based on valid bitmap information stored in the first memory,
wherein the valid bitmap information indicates whether data stored in memory cells corresponding to the physical address corresponding to the second PPN is valid.

5. The method of claim 1, wherein the second LPN is an LPN continuous from the first LPN, and
wherein the estimating of the second PPN corresponding to the second LPN of the first region includes estimating a PPN continuous from the first PPN as the second PPN.

6. The method of claim 1, further comprising:
updating the estimated second PPN to a PPN corresponding to the second LPN in response to determining that the third LPN is matched with the second LPN.

7. The method of claim 1, wherein the detecting of the first region in which the error has occurred in the mapping table stored in the first memory includes detecting the first region in which uncorrectable error correction code (UECC) has occurred in the mapping table.

8. A memory controller comprising:
a processing circuit configured to control an operation of a nonvolatile memory device; and
a first memory configured to store a mapping table including mapping between a logical page number (LPN) and a physical page number (PPN) used in the nonvolatile memory device,
wherein the processing circuit includes:
an error detection unit configured to detect a first region in which an error has occurred in the mapping table,
a PPN estimation unit configured to estimate a second PPN corresponding to a second LPN of the first region based on a first PPN corresponding to a first LPN of a second region in which an error has not occurred in the mapping table, and
an LPN checking unit configured to read metadata recorded in memory cells corresponding to a physical address of the estimated second PPN from the nonvolatile memory device and determine whether a third LPN included in the metadata is matched with the second LPN.

9. The memory controller of claim 8, wherein the processing circuit further includes:
a mapping pattern determination unit configured to determine whether a mapping pattern of the mapping table is a sequential pattern, based on a plurality of LPNs of the second region and a plurality of PPNs corresponding to the plurality of LPNs.

10. The memory controller of claim 8, wherein the processing circuit further includes a validity verification unit configured to determine whether the second PPN is valid.

11. The memory controller of claim 10, wherein the validity verification unit is configured to determine whether the second PPN is valid, based on valid bitmap information stored in the first memory,
wherein the valid bitmap information indicates whether data stored in memory cells of the nonvolatile memory device corresponding to the physical address corresponding to the estimated second PPN is valid.

12. The memory controller of claim 8, wherein the second LPN is an LPN continuous from the first LPN, and
wherein the PPN estimation unit is configured to estimate that a PPN continuous from the first PPN is the second PPN.

13. The memory controller of claim 8, wherein the processing circuit further includes:
an error recovery unit configured to update the second PPN to a PPN corresponding to the second LPN in response to the determination that the third LPN is matched with the second LPN.

14. The memory controller of claim 8, wherein the error detection unit is configured to detect the first region in which uncorrectable error correction code (UECC) has occurred in the mapping table.

15. A storage device comprising:
a nonvolatile memory device configured to store data; and
a storage controller configured to:
control an operation of the nonvolatile memory device,
detect a first region in which an error has occurred in a mapping table,
estimate a second PPN corresponding to a second LPN of the first region based on a first PPN corresponding to a first LPN of a second region in which an error has not occurred in the mapping table,
read metadata recorded in memory cells corresponding to a physical address of the estimated second PPN from the nonvolatile memory device, and
determine whether a third LPN included in the metadata is matched with the second LPN.

16. The storage device of claim 15, wherein the storage controller is further configured to determine whether a mapping pattern of the mapping table is a sequential pattern, based on a plurality of LPNs of the second region and a plurality of PPNs corresponding to the plurality of LPNs.

17. The storage device of claim 15, wherein the storage controller is further configured to determine whether the estimated second PPN is valid.

18. The storage device of claim 17, wherein the storage controller is further configured to determine whether the second PPN is valid, based on valid bitmap information, and
wherein the valid bitmap information indicates whether data stored in memory cells of the nonvolatile memory device corresponding to the second PPN is valid.

19. The storage device of claim 15, wherein the second LPN is an LPN continuous from the first LPN, and
wherein the storage controller is configured to estimate that a PPN continuous from the first PPN is the second PPN.

20. The storage device of claim 15, wherein the storage controller is further configured to update the estimated second PPN to a PPN corresponding to the second LPN in response to the determination that the third LPN is matched with the second LPN.
